(19) United States
(12) Patent Application Publication
(10) Pub. No.: US 2020/0334492 A1
(43) Pub. Date: Oct. 22, 2020

(54) ABLATION ON OBSERVABLE DATA FOR DETERMINING INFLUENCE ON MACHINE LEARNING SYSTEMS

(71) Applicant: CHATTERBOX LABS LIMITED, Greater London (GB)

(72) Inventors: Zheng Yuan, Greater London (GB); Stuart Battersby, Greater London (GB); Gülce Kale, Greater London (GB); Niall McCarroll, Greater London (GB); Danny Coleman, Greater London (GB)

(21) Appl. No.: 16/387,815

(22) Filed: Apr. 18, 2019

(51) Int. Cl. G06K 9/62; G06N 20/00; G06F 17/27; G06K 9/72

(52) U.S. Cl. CPC G06K 9/623; G06N 20/00; G06K 9/6263; G06K 9/726; G06F 17/278; G06F 17/2715

(57) ABSTRACT

The approach described herein provides a novel means of determining the influence of sub-components of raw input data on machine learning predictions. This is applied directly to the raw observed data, rather than to embedded data, such that the influence is determined with respect to real-world observable features that are recognizable to the user, rather than latent features that may have no meaning to the user. This is achieved without requiring retraining of the model, and therefore avoids the additional computation necessary to recalculate model parameters. This provides a simple and efficient method for determining which sub-components of the input data provide the greatest influence over the generation of individual prediction(s).

### TECHNICAL FIELD

The present disclosure relates to improvements in the computational efficiency and accuracy of determining the influence of observable feature(s) on a machine learning model. In particular, but without limitation, embodiments determine the influence of real-world observed features, rather than latent features, to help users better understand the effect of observed data on machine learning models. By determining the influence on observed features, specific embodiments provide improvements in the computational efficiency and flexibility through avoiding the need for repeated retraining of the model.

### BACKGROUND

Machine learning methods generally aim to make predictions based on models that have been trained based on observed (training) data. Generally, machine learning training methods adjust the parameters of a given model in an attempt to minimize some form of loss function or maximize some form of reward function based on predictions made by the model. One example of this is the adjustment of parameters to minimize the prediction error of the model.

Generally, these methods require observed data (such as text or images) to first be converted into vector format for input into the model. For instance, text can be processed to tokenize the text to break the text into such as individual words before each word is converted into a word vector.

With respect to images, each pixel can be represented as a number (e.g. based on the intensity and/or color of the pixel) and the array of pixels can be unraveled to form a vector representing the observed image.

Whilst vectors for observed data are in an appropriate format for inputting into a machine learning model, they can be difficult to interpret by a user, particularly where the user is not an expert in machine learning. Interpretability can be further hindered when observations are embedded through a mapping into a latent space.

Latent spaces generally represent information via its underlying attributes. Each observation can be converted into an embedded vector through a mapping onto the latent space. This then represents the information in terms of latent (or hidden) variables. Latent variables are variables that are inferred from observable variables, rather than being directly observed or measured from the real-world environment.

Utilizing latent variables can improve performance of a machine learning model by representing the observed information more efficiently in the form of its underlying characteristics.

Having said this, as the latent variables are unobserved features that do not necessarily directly relate to observable concepts, they are often difficult to interpret, as they do not necessarily have a corresponding name or label that is interpretable to a user.

Furthermore, many predictions made by machine learning models can be difficult to understand for users, particularly if the users are not experts in machine learning. In this case, a predictive model can appear as a “black box”, and the user may be unsure as to the quality of the predictions made, or the effect of the input data on the predictions.

Whilst it is possible to determine the influence of an embedded feature on a prediction by a machine learning model, this can be difficult to interpret by a user, as the feature may not relate to an interpretable real-world concept. Furthermore, this can require the machine learning model to be retrained, which can be computationally expensive.

There is therefore a need for an improved means of identifying the influence of data on machine learning predictions.

### SUMMARY

The embodiments described herein combine a number of mathematical techniques to address the problem of efficiently determining the effect of subsets of raw input data on predictions by machine learning models.

The embodiments described herein provide improvements in computational efficiency and interpretability to the determination of the influence of inputs on predictions. Existing approaches rely on removing individual latent features and measuring the influence on the model predictions. This often requires retraining the model, resulting in additional computation steps. In contrast, the embodiments described herein rely on the removal or adaptation of meaningful components from the input/observed data leading to the removal or modification of combinations of multiple latent features (after the adapted input has been embedded onto the latent space). An attempt to directly find influential combinations of multiple latent features similar to those uncovered by our method would involve exploring a large search space requiring the removal and/or modification of every possible combination of latent features and would be computationally very expensive compared to the present methods. The embodiments described herein therefore dramatically improve the performance of the identification of meaningful components of inputs that contribute towards model predictions.

According to a first aspect there is provided a computer-implemented method for determining an influence of a component of an input on a prediction generated according to a machine learning model. The method comprises: obtaining an input comprising observations, each observation including a corresponding value for one or more observable variables; dividing the input into components, each component comprising a subset of the observations; and obtaining a measure of confidence in a first prediction, the first prediction being generated through inputting the input into the machine learning model. The method further comprises, for each component: forming an adjusted input by adjusting, within the input, the subset of the observations corresponding to the component; obtaining a measure of confidence in a second prediction, the second prediction being generated through inputting the adjusted input into the machine learning model; and determining the influence of the component on the first prediction by calculating a difference between the measure of confidence in the first prediction and the measure of confidence in the second prediction. The method further comprises outputting an indication of the influence of one or more of the components.

In light of the above, embodiments are able to determine the influence of components (e.g. subsections or clusters) of an input on a prediction derived from the input. As the influence is determined through direct adjustment of the components in the input, there is no need to adjust model parameters or to have access to the inner functioning of the machine learning model (such as any mapping onto latent variables). The embodiments described herein are therefore applicable to any machine learning model and provide improvements in computational efficiency through avoiding retraining of the model.

The values for each observation can indicate any form of observable variable, for instance, indicating text (e.g. a word) or image information (e.g. a pixel). Observable variable means that the variable can be observed and directly measured, in contrast to latent variables that are not directly observable, but are instead inferred from observable variable(s).

Outputting an indication of the influence of one or more components may comprise outputting an indication a set of one or more components (e.g. highlighting the set within the input) and outputting a corresponding influence for each component in the set. Alternatively, or in addition, the indication of the influence might be through a ranking or one or more components by influence, or by outputting only a set of one or more of the most influential components and/or a set of one or more of the least influential components.

According to an embodiment the difference in the measure of confidence in the first prediction and the measure of confidence in the second prediction is a difference relative to the measure of confidence in the first prediction. That is, calculating the difference between the measure of confidence in the first prediction and the measure of confidence in the second prediction might comprise subtracting the measure of confidence in the second prediction from the measure of confidence in the first prediction to determine a change in the measure of confidence, and dividing the change in the measure of confidence by the measure of confidence in the first prediction to obtain the (relative) difference in the measure of confidence. Taking the relative difference allows the influence score to be comparable across different models and observations.

According to an embodiment the machine learning model is a classifier and the measure of confidence in the first prediction is a confidence score for a classification of the input and the measure of confidence in the second prediction is a confidence score for a classification of the adjusted input. The classification of the input and the classification of the adjusted input might relate to the same class. The classifier may be configured to output a classification score for each of a plurality of classes. In this case, a corresponding prediction might be provided for each class. The influence of a component may be determined for each class based on comparisons of the corresponding confidence scores for the first and second predictions for the class.

According to a further embodiment the measure of confidence in the first prediction is an error in the first prediction and the measure of confidence in the second prediction is an error in the second prediction. Any measure of error may be used, such as mean squared error.

According to a further embodiment the first prediction is a first action and the second prediction is a second action and the measure of confidence in the first prediction is a reward for a first action and the measure of confidence in the second prediction is a reward for the second action. Accordingly, the method may be applied to determine influence on a machine learning agent configured to take actions in response to an input. The agent may have been trained via reinforcement learning. The rewards may be determined by a reward function. Equally, the rewards may be losses (through the provision of negative rewards) calculated through a loss function.

According to an embodiment obtaining a measure of confidence in a first prediction comprises inputting the input into the machine learning model to determine the first prediction and determining the measure of confidence in the first prediction. The measure of confidence may be output by the machine learning model or may be determined based on analysis of the prediction (e.g. based on a ground truth result, for instance, based on labelled data).

According to an embodiment obtaining a measure of confidence in the second prediction comprises inputting the adjusted input into the machine learning model to determine the second prediction and determining the measure of confidence in the second prediction. Again, the measure of confidence may be output by the machine learning model or may be determined based on analysis of the prediction (e.g. based on a ground truth result, for instance, based on labelled data).

According to an embodiment obtaining a measure of confidence in the first prediction comprises: sending the input to an external system configured to input the input into the machine learning model to determine the first prediction and determine the measure of confidence in the first prediction; and receiving the measure of confidence in the first prediction from the external system. Accordingly, the method need not have direct access to the machine learning model.

According to an embodiment obtaining a measure of confidence in the second prediction comprises: sending the adjusted input to an external system configured to input the adjusted input into the machine learning model to determine the second prediction and determine the measure of confidence in the second prediction; and receiving the measure of confidence in the second prediction from the external system.

According to a further embodiment the input comprises a set of words, with each observation representing a corresponding word, and each component comprises a corresponding group of one or more words.

According to a further embodiment the input is divided into components based on a semantic and/or syntactic classification of each word. Accordingly, natural language processing method may be employed to extract components from the input. It should be noted that the extraction of these components is independent to any extraction of features that might be applied by the machine learning model, as the components do not form features for the machine learning model, but instead relate to aspects of the input that are adjusted prior to input into the machine learning model.

According to a further embodiment, each component comprises a group of one or more words having a corresponding semantic and/or syntactic classification. That is, each component may be grouped according to corresponding semantic and/or syntactic classifications.

According to a further embodiment dividing the input into components comprises one or more of: identifying one or more words within the input and assigning each word to a corresponding component; identifying one or more noun phrases within the input and assigning each noun phrase to a corresponding component; identifying one or more grammatical relations within the input and assigning each grammatical relation to a corresponding component; and identifying one or more named entities within the input and assigning the each named entity to a corresponding component. Individual words (or unigrams), noun phrases, grammatical relations and named entities have been found to be particularly important components of text, particularly the classification of text. Forming components for each of these groups helps to provide indicators of influence on these important components that can be helpful in indicating how a particular prediction came to be made.

According to a further embodiment identifying one or more words comprises identifying one or more words having one of one or more predefined semantic and/or syntactic classifications.

According to a further embodiment the one or more predefined semantic and/or syntactic classifications comprise one or more of noun, verb, adjective, adverb, negative, determiner, question word and auxiliary verb. These have been found to be particularly important components in machine learning predictions based on text and, in particular, classification.

According to a further embodiment identifying one or more named entities comprises identifying one of more groups of one or more words referring to a corresponding entity.

According to a further embodiment the corresponding entity comprises one or more of a location, person, organisation, value of currency, percentage, date or time. These have been found to be particularly important components in machine learning predictions based on text and, in particular, classification.

According to an embodiment a noun phrase is a phrase having a noun or pronoun at its head. A noun phrase may be a phrase functioning as a noun or pronoun within the input text.

According to an embodiment a grammatical relation is a pair of words linked by a corresponding syntactic dependency. That is, one of the pair of words (a dependent word) may be syntactically dependent on the other of the pair of words (a parent word). This may be a direct dependency, rather than the parent word merely being an ancestor of the dependent word (e.g. a grandparent) within a corresponding syntactic dependency tree representing the syntactic dependencies between the words in the text.

According to a further embodiment there is provided a computing system comprising one or more processors configured to perform any of the methods described herein.

According to a further embodiment there is provided a non-transitory computer readable medium comprising instructions that, when executed by one or more processors, cause the one or more processors to perform any of the methods described herein.

### BRIEF DESCRIPTION OF THE DRAWINGS

Arrangements of the present invention will be understood and appreciated more fully from the following detailed description, made by way of example only and taken in conjunction with drawings in which:

FIG. 1 shows a method of determining a prediction using a machine learning model;

FIG. 2 shows a method of determining the importance of observed features on predictions made by a machine learning model according to an embodiment;

FIG. 3 shows a method for determining the importance of observed features on text classifications according to an embodiment; and

FIG. 4 shows a computing system for performing the methods described herein.

### DETAILED DESCRIPTION

The approach described herein provides a novel means of determining the influence of sub-components of raw input data on machine learning predictions. This is applied directly to the raw observed data, rather than to embedded data, such that the influence is determined with respect to real-world observable features that are recognizable to the user, rather than latent features that may have no meaning to the user. This is achieved without requiring retraining of the model, and therefore avoids the additional computation necessary to recalculate model parameters. This provides a simple and efficient method for determining which sub-components of the input data provide the greatest influence over the generation of individual prediction(s).

The embodiments described can efficiently therefore calculate the relative influence (or importance) of sub-components of an input. This can provide a ranked list of observed the most important sub-components of the input that most influenced the generation of a prediction by a machine learning model. This provides a simple and efficient means for the user to ascertain the type and validity of the prediction.

A two-step approach is proposed that can be applied to any machine learning model to study the behavior of the model and provide insight into predictions by the model:
Step 1: adjust (e.g. ablate) the raw input data by adapting (e.g. deleting/occluding) components that are sensible to humans (e.g. words, phrases, or groups of words, objects in images), which are identified using machine learning technologies, such as natural language processing techniques;
Step 2: determining the importance of various components within the input data and how they influence the prediction that the model makes on that data.

Whilst it is possible to ablate, or otherwise edit, embedded features that are input into the machine learning model to determine the importance of such embedded features, this would not necessarily be interpretable by the end user, as they relate to latent, rather than observable, variables.

An additional advantage of perturbing the observed features rather than the features of the model is that this ensures that the methods are model-agnostic; they may be applied to any machine learning model without having to modify the model and without having to adapt the method to the model. The methods described herein may even be applied remotely to a model without access to the inner workings of the model, treating the model as a black box. Furthermore, the methods may be implemented without retraining the model, and therefore are more efficient than alternatives that require the model parameters to be updated (e.g. based on ablation of a latent variable).

### Machine Learning Predictions

Generally, a machine learning system is configured to generate a prediction in the form of a predicted data point Y in response to an input X into a model M.

The input X is a single instance of observed data that is input into the model in order to obtain the prediction. It may be an image, text (e.g. a set of words) or sensor measurements. Generally, the input X relates to observable data in an observable environment. That is, the input includes observable features, rather than latent features. Accordingly, the input X includes a set of n observed values {x}ᵢ₌₁². This may be in the form of a set of observations, with each observation one or more corresponding observed values. For instance, an observation might relate to a signal pixel, with the observation including a set of observed values, such as pixel colour, pixel intensity, etc.

The prediction Y might be a set of one or more confidence scores for classification, might be an action for application to an environment, or might be a synthetically generated data point. The prediction Y is a single instance of predicted data. The prediction includes one or more predicted values. That is, the prediction Y comprises the set of m predicted values {yᵢ}ᵢ₌₁^{m}, wherein m≥1. Each prediction has an associated measure of confidence (for instance, a classification confidence score, a prediction accuracy, or a reward for predicting a particular action). This represents the confidence that the prediction is accurate or correct. It can therefore be considered an accuracy score.

Machine learning models are based on observed data, as they are models having parameters that have been fit to the observed data based on a number of training steps.

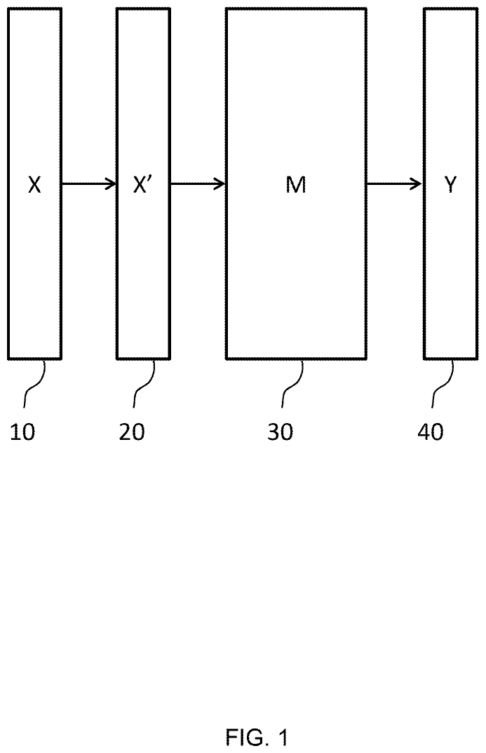

FIG. 1 shows a method of determining a prediction using a machine learning model. The observation, X, 10 undergoes preprocessing (e.g. by a preprocessing component) to convert the observation, X, 10 into a machine learning format to produce a processed input, X′, 20. The processed input X′ is in a format appropriate for inputting into the model M, 30. In this case, the processed input X′ is an embedding of the observation X and therefore includes latent variables x′. These latent variables x′ relate to inferred features in the observation X but do not necessarily have a readily understandable meaning to users. Once the processed input X′, 20, is input in to the model M, 30, a prediction Y, 40, is output.

Whilst it is possible to determine the importance of the latent variables on a particular prediction, this might not have any meaning to the user when it comes to determining why a particular prediction was made. Furthermore, as it relates to the processed input X′, rather than the observation X, it might not be immediately obvious to the user how the observed data might be adapted to change or improve the prediction.

In addition, the calculation of importance based on the processed input X′ requires access to the latent variables x′. For instance, if determining the importance of a latent variable, the latent variable may be deleted and the system may be retrained without using this latent variable to determine its influence on the prediction. This, however, can provide a large computational burden, as retraining a model can be computationally expensive. Equally, the retrained model is, by definition, different to the original model, so there is no guarantee that the predictions from the retrained model have any significance when assessing feature importance in the original model.

Furthermore, calculating the importance of the latent variables on the model determines the importance of a given attribute on a prediction (e.g. a latent variable linked to the contrast within an image), rather than the importance of a given component of an observation (e.g. a specific car shown within an image).

The calculation of the importance of a specific latent variable might be possible if the model is implemented locally, but is not possible where the machine learning model (including the preprocessing components) is inaccessible, for instance due to it being implemented remotely. In the case where the model (including the preprocessing component that produces the processing input X′) is a black box, it would not be possible to access the processed input X′ to determine their relative importance.

To solve the above issues, the embodiments described herein determine the relative importance of features directly taken from the observed data through the adaptation of the (raw) observed data. This allows importance values to be determined for human-understandable features (observed features) and allows the calculation of importance values even without access to the inner functioning of the model. Importantly, this can be achieved without requiring the model to be retrained, thereby improving the efficiency of the system.

### Feature Importance

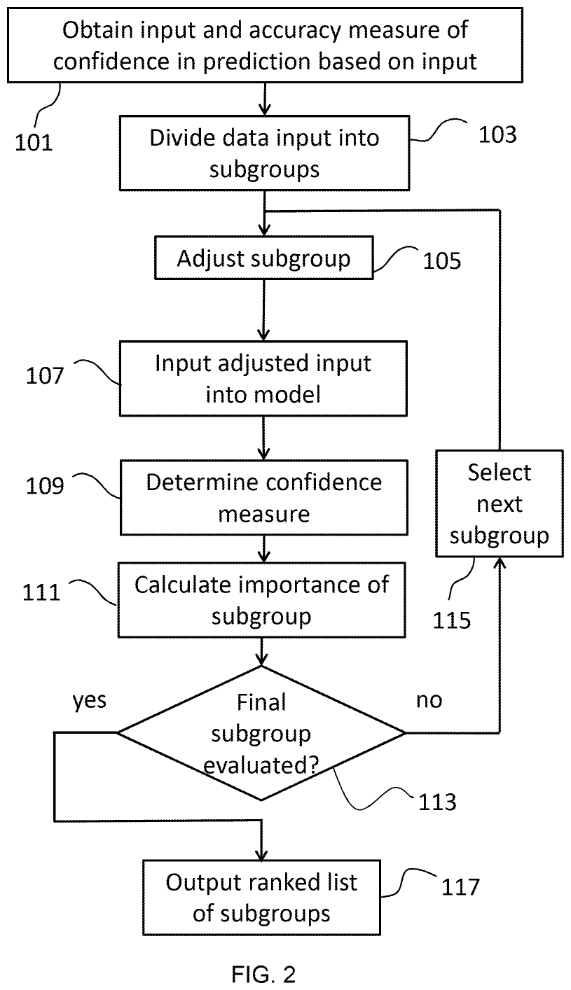

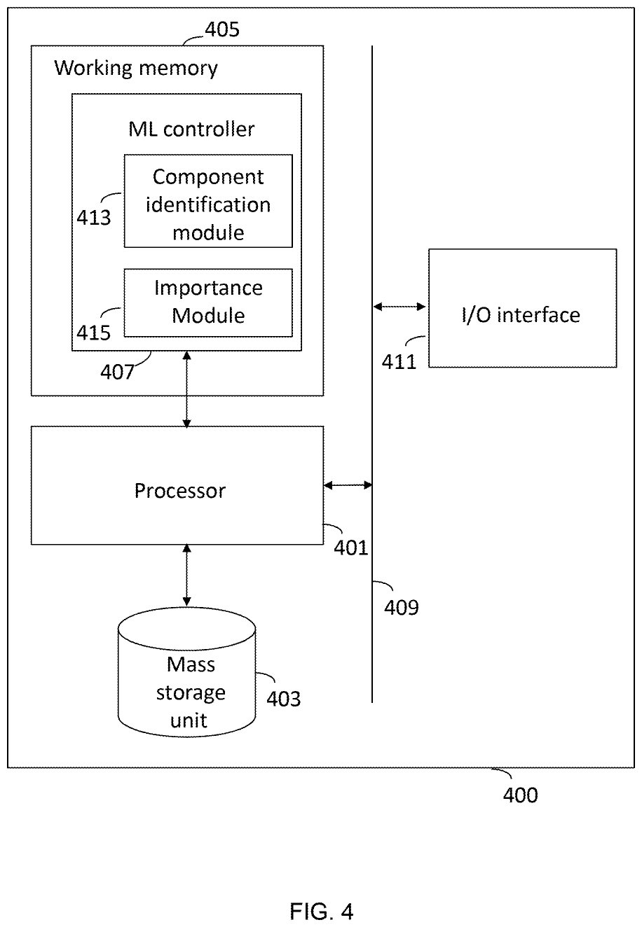

FIG. 2 shows a method of determining the importance of observed features on predictions made by a machine learning model according to an embodiment. This may be performed by a computing system, such as that shown in FIG. 4.

An input is obtained, along with a measure of confidence associated with a prediction determined from the input 101. An input is a single instance of observed data (e.g. an observed data point). This includes information that has been observed or measured. It may be a picture, set of text or a video. It is a single instance of observed data upon which a prediction by a machine learning model may be based. Crucially, it is observed data in a format that is recognizable to the user, and prior to any processing that may be necessary to input the data into the machine learning model (e.g. feature extraction).

The input may be obtained as part of this method through measurement (i.e. through taking an input through one or more sensors). Alternatively, the input might be received from storage, from an input device (e.g. a keyboard) or from an external system that has performed a measurement or received the input through a corresponding input device.

The measure of confidence represents the confidence in (or accuracy of) a prediction made by the machine learning model based on the input (in response to the input being input into the machine learning model). This may be obtained directly as part of the method through applying the machine learning model to the input. Alternatively, this may be received from an external system. In either case, the measure of confidence represents the confidence in the prediction obtained based on the input. The measure of confidence might be a confidence score representing a confidence in the prediction (e.g. the confidence in a classification, where the model is a classifier), or may be an alternative measure such as (prediction) error (e.g. mean-squared error).

The machine learning model may be stored locally and accessed in order to obtain the prediction. In this case, the machine learning model may be run by the computing system to process the input. Alternatively, the machine learning model may be stored in an external system. In this case, the external system might run the machine learning model to process the input.

The input is then divided into a set of subgroups (or components) of observed data 103. Each subgroup is considered a separate observation within the input. Any method may be used to divide the input into subgroups. A clustering method may be used to cluster the data into recognizable subgroups. Alternatively, one or more classifiers may be used to divide the input into recognizable subgroups. Alternatively, a set of rules might be utilized to divide the observation into subgroups. For instance, text may be divided into unigrams, each representing a different word within the text. Alternatively, an image might be divided into different regions within the image; for instance, predefined regions or regions identified through object recognition.

At the next step, a subgroup is selected and is adjusted 105 relative to the other subgroups in the input. The adjustment might involve the blanking or deletion of the subgroup from the input, the application of a weighting to the subgroup (e.g. increasing or decreasing information values within the subgroup), or the permutation of values within the subgroup. For instance, where the subgroup represents a word from a set of words within input text, the adjustment might delete the word from the input. Where the subgroup represents a set of pixels within an image, the adjustment might involve increasing or decreasing intensity values of the pixels, or permuting pixels (swapping pixel values). The adjustment forms an adjusted input (the input after adjusting the subgroup).

The adjusted input is input into the model 107. This may either be through the computing system inputting the adjusted input into the model or may be through the adjusted input being sent to an external system that applies the model to the adjusted input and returns a prediction to the computing system. In either case, a prediction is obtained from the adjusted input.

The confidence measure for the adjusted input is then determined 109. The same form of accuracy measure is used as for the measure of confidence for prediction from the (unadjusted) input.

The importance (or influence) of the selected subgroup (the adjusted subgroup) is then determined 111. This is determined by determining the relative change in the measure of confidence through the adjustment of the selected subgroup. That is, the influence Inf(Oᵢ) of subgroup Oᵢ is:

In_{f}(Oᵢ)=f(Xᵢ)−f(X₀)/f(X₀)

where f(X₀) is the measure of confidence for prediction based on the input Xₒ and f(Xᵢ) is the measure of confidence for the prediction based on the adjusted input Xᵢ.

Whilst the difference in accuracy score (rather than the relative difference) might also be utilised, taking the relative difference (by dividing by the measure of confidence for the input) allows the influence score to be comparable across different models and observations.

It is then determined whether the influence score for the final subgroup has been calculated 113. If not, then the next subgroup in the set of subgroups is selected 115 and the method loops back to step 105 to adjust the newly selected subgroup and calculate the influence of the newly selected subgroup.

Once influence scores have been calculated for each subgroup, the subgroups are ranked in order of their influence 117 and the ranked list is output to the user. This allows the user to evaluate the influence of the subgroups (observed clusters or components) within the input upon the prediction. This helps the user determine why the particular prediction was made by the model.

Identifying influential components can help users to debug or further improve the machine learning model. For instance, if a classifier is producing classifications that appear to be erroneous (or at least anomalous), identifying the influential components that caused these erroneous classifications can help a user to assess whether the data is indeed erroneous (e.g. through comparison to the influential components within the data).

For example, a classification may appear on the face of it to be erroneous, but there may be a good reason for that classification. Identifying the influential component within the input data that caused the classification can help the user determine whether the classification is correct. For instance, in a classifier that attempts to identify malicious emails an email may appear on the face of it to be benign but might have a difficult to identify issue (such as an incorrect URL that directs the user to a malicious site). The methods described herein are able to direct the user's attention to the most important component within the observed data (the URL within the email in this case) to the help assess the accuracy of the classification.

Furthermore, identification of influential components can help improve the accuracy of a machine learning model. For instance, if a number of inputs that result in erroneous predictions all have similar influential components within them, then this might indicate that the model needs to be improved for predictions based on such components (e.g. through training the model with more training instances containing such components or through adding additional features that help to improve identification of these components).

The above methods relate generally to identifying the influential (or important) components observed data that contributed towards a prediction. These are general to any machine learning methods and any form of observed data. Having said this, the advantages of this general teaching can be better understood with reference to the specific embodiment applied to a text classifier.

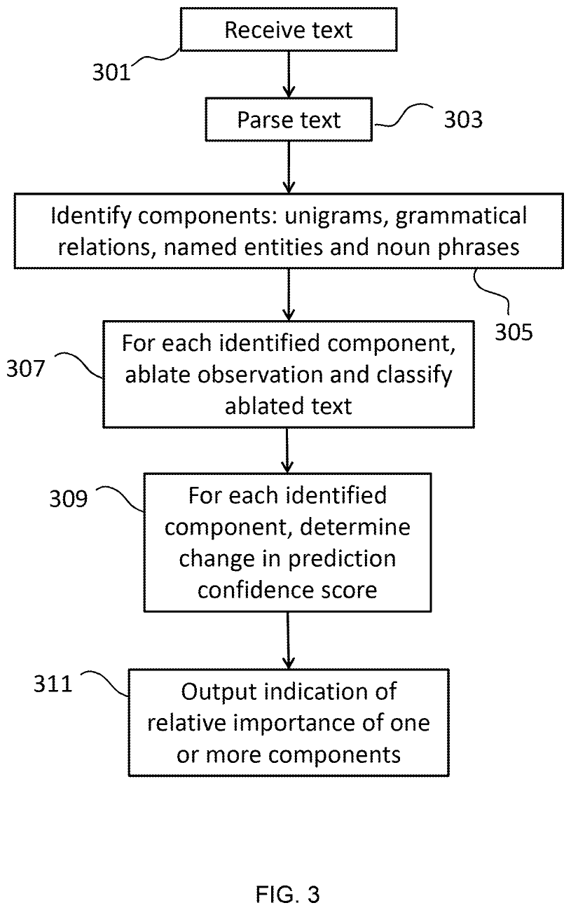

FIG. 3 shows a method for determining the importance of observed features on text classifications according to an embodiment.

The present embodiment makes use of natural language processing (NLP) methods to extract components in the form of groupings of words from an input observation in the form of a set of words.

The method begins with the receipt of text in the form of a set of words 301. The text may be received in machine readable format; however, it is received prior to the extraction of features within the text (such as latent variables).

The text is the parsed 303 in order to identify syntactic and/or semantic relationships between the words. This classifies each word according to its syntactic and/or semantic role within the text. The word classifications are then used when it comes to identifying components within the text (subgroupings or subcomponents of the text).

The text is then divided into components 305. Each component is a selection of one or more words that has a particular semantic or syntactic function within the text. Importantly, as these components relate to subsets of the original input observation data they are both human-recognisable (as they relate to directly observed data) and model-sensitive. Each of these components is identified so that they may be adjusted (in this case, ablated) in order to determine their importance on the machine learning prediction. Generally, each component is identified based on the semantic and/or syntactic word classifications (e.g. to group words with corresponding classifications).

Whilst a variety of types of components may be selected, the present embodiment makes use of four specific types of word groupings to better understand machine learning predictions for textual data:
Unigram: an individual word
Grammatical Relation (GR): a pair of words that bears a syntactic function
Named Entity (NE): a real-world object
Noun Phrase (NP): a phrase that has a noun as its head word

For unigrams, a simple embodiment identifies each word within the text as a separate component. Having said this, the present embodiment extracts only words of specific word classes. In one embodiment, words are extracted from the text according to the following word classes: nouns, verbs, adjectives, adverbs, negatives, determiners, question words and auxiliary verbs. This provides a list of all content words plus a few function words within the input text that have found to be particularly important when it comes to natural language processing (e.g. classifying text).

For example, in the phrase “Three years after high-dose buprenorphine preparations were first marketed in France, we examine their use as replacement therapy for heroin addiction”, the word “Three” is a unigram.

For named entity extraction, named entities within the text are identified. Each named entity is a group of one or more words that refers to an entity (according to its semantic or syntactic classification). In a specific embodiment, a group of one or more words is a named entity if it refers to a location, person, organisation, money, percentage, date or time; however, any form of named entity may be utilised, depending on the context of the input language and the prediction task.

For example, in the phrase “Three years after high-dose buprenorphine preparations were first marketed in France, we examine their use as replacement therapy for heroin addiction”, examples of named entities include “France”, “first” and “Three years”.

The present embodiment extracts each noun phrase from the text. A noun phrase is a phrase (a word or group of words) that has a noun or (indefinite) pronoun at its head, or that functions as a noun or (indefinite) pronoun within a sentence. A noun phrase often functions in a sentence as a subject, object or prepositional object. In a specific embodiment, a noun phrase is defined as the smallest phrase unit without any nested noun phrases, verb phrases or preposition phrases.

For example, in the phrase “Three years after high-dose buprenorphine preparations were first marketed in France, we examine their use as replacement therapy for heroin addiction”, examples of noun phrases include “Three years”, “high-dose buprenorphine preparations”, “their use”, “replacement therapy” and “heroin addiction”.

The method also identifies grammatical relations within the text. A grammatical relation is a pair of words that bears a syntactic function. These words are generally linked by a syntactic dependency, with one word being the head and the other word being a dependent of the head. Examples of grammatical relations include subject, object, complement, specifier, predicative, etc.

For example, in the phrase “Three years after high-dose buprenorphine preparations were first marketed in France, we examine their use as replacement therapy for heroin addiction”, examples of grammatical relations include (for, addiction), (examine, use), (marketed, France), (we, examine) and (preparations, marketed). Each grammatical relation is represented as a set of words (a pair of words) as opposed to a span of words as they need not be consecutive within the original input. The same applies to any of the other types of component, which may simply include a set of one or more selected words.

For each identified component (subgroup taken from the input), an adjusted, or perturbed, input is produced 307. The adjusted input is adjusted through the adjustment of the identified component within the input. In this case, the adjusted input is produced through the ablation (deletion or removal) of the component from the input text.

Taking the above example phrase, ablating the noun phrase “high-dose buprenorphine preparations” results in the adjusted (ablated) input “Three years after were first marketed in France, we examine their use as replacement therapy for heroin addiction”.

Each adjusted input is then input into the model to determine a corresponding measure of confidence (in this case, a prediction confidence score) and the change in measure of confidence caused by each adjustment is calculated 309.

In the present embodiment, a classification model is being assessed, with a corresponding confidence score representing the confidence that the input matches a particular class. The classification model (classifier) might classify between two or more classes. The classifier can output a confidence score for the input relating to each class (vs. the input belonging to any of the other classes). In this case, an influence score can be calculated for each confidence score (each class). This therefore provides an indication of the influence of the component on each prediction (each classification for each class).

As mentioned above, where a multi-class classifier is being assessed, the change in confidence for each class is determined. This produces an influence score for each class. The present embodiment proposes a scheme to classify and rank influential components for each class:
positive influences: if the removal of the component decreases the model prediction confidence score for the class, it is defined as a positive influence on that class;
negative influences: if the removal of the component increases the model prediction confidence score for the class, it is defined as a negative influence on that class;
all positive influences and negative influences may be ranked based on the relative difference.

Whilst length normalization may be applied to confidence scores, the present embodiment makes use of raw confidence scores without any length normalisation as normalization has not been found to improve performance.

Once the change in prediction confidence score has been determined, an indication of the relative importance of one or more components is output 311. This may be through an indication of a set of one or more of the most important (most influential) components, or an indication of a set of one or more of the least important (least influential) components. For instance, the input may be displayed with one or more of the most influential (or least influential) components highlighted or otherwise indicated within the input.

Alternatively, a ranked list of components (ranked according to importance) might be output. The corresponding influence score may be output with each output component.

In the present embodiment, the received text is unstructured, so that it must be parsed in order to identify semantic and/or syntactic relationships. Having said this, in an alternative embodiment, structured text is received, for instance, in the form of a syntactic or semantic graph. In this case, the components may be extracted without requiring a semantic and/or syntactic parse.

For example, a spam classifier applied to the following phrase might classify the text as not spam with a confidence score of 0.59:

“Hi its Kate how is your evening ? I hope i can see you tomorrow for a bit but i have to bloody babyjontet ! Txt back if u can. :) xxx”

The user may be unsure as to why this message was deemed not spam, relative to other potential inputs. Applying the present embodiment to this text can identify the phrase “Txt back” as the most important component within the text, with an influence score of 8.14. Equally, the phrase “u can” is identified as the least important component, with an influence score of 2.15.

Each output might not only include the component and the corresponding influence score, but might also include the location of each part of the component within the original input. For text, this might be the position of the word within the text (how many words in to the text the word is located). For an image, this might be the pixel locations for the component (either as a region or span or pixels, or as a list of the indexes of the pixels within the component). Importantly, as the present embodiments work on specific components of observed data, they relate to specific instances of that data.

In the above example, the word “I” occurs multiple times. If the word embeddings of the words were used, the method would be unable to differentiate between different instances of the word. In the present embodiment, each instance is considered (given their differing locations within the input text), as each instance might have a different impact on the prediction depending on its context within the input.

A filtered list of the components, influence scores, positions and component classifications in the present example is shown below:

(8.1378) [‘back’, 26], [‘Txt’, 25], gr_advmod
(7.7863) [‘:)’, 31], [‘xxx’, 32], gr_compound
(6.9146) [‘i’, 19], unigram_FW
(6.9083) [‘I’, 8], [‘hope’, 9], gr_nsubj
(6.7680) [‘.’, 30], [‘Txt’, 25], gr_punct
(6.0927) [‘i’, 10], unigram_FW
(6.0738) [‘Txt’, 25], unigram_NN
(5.6791) [‘can’, 29], [‘Txt’, 25], gr_advcl
(5.6032) [‘i’, 19], [‘have’, 20], gr_nsubj
(5.3013) [‘i’, 10], [‘see’, 12], gr_nsubj
(5.1248) [‘I’, 8], unigram_PRP
(5.1034) [‘your’, 5], [‘evening’, 6], gr_nmod:poss/np_np
(4.3232) [‘:)’, 31], unigram_NN
(4.1577) [‘your’, 5], unigram_PRP$
(3.4182) [‘for’, 15], [‘bit’, 17], gr_case
(3.0862) [‘for’, 15], unigram_IN
(2.7818) [‘but’, 18], unigram_CC
(2.7063) [‘back’, 26], unigram_RB
(2.4544) [T, 24], unigram_.
(2.3034) [‘bloody’, 22], [‘babyjontet’, 23], gr_amod/np_np
(2.3013) [‘to’, 21], [‘babyjontet’, 23], gr_case
(2.2261) [‘babyjontet’, 23], [‘have’, 20], gr_nmod
(2.1486) [‘u’, 28], [‘can’, 29], gr_nsubj

In the above, the number in parenthesis is the confidence score, the values in brackets are the components and their corresponding locations within the observation, and the final term represents the type of component (e.g. unigram_NN is a noun unigram).

In light of the above, the embodiments described herein are able to provide a quantitative measure of the influence of a particular component of an observation on a machine learning prediction made based on that observation. This is achieved without requiring internal access to the machine learning model, or requiring any retraining of the model. The methods are therefore an efficient means of providing influence scores and are applicable to any form of machine learning prediction. As the embodiments directly adjust observations prior to their processing for use in the prediction, they are able to provide influence scores for directly observed components that are easy for the end user to understand (relative to machine learning features). This helps provide an improved means of explaining the origin of machine learning predictions. The influence scores can be used to advise users as to how to improve the machine learning model or how to achieve improved results (e.g. through editing the observations).

### Computing System

While the reader will appreciate that the above embodiments are applicable to any commuting system for recognizing user inputs, a typical computing system is illustrated in FIG. 4, which provides means capable of putting an embodiment, as described herein, into effect. As illustrated, the computing system 400 comprises a processor 401 coupled to a mass storage unit 403 and accessing a working memory 405. As illustrated, a machine learning (ML) controller 407 is represented as a software product stored in working memory 405. However, it will be appreciated that elements of the ML controller 407 may, for convenience, be stored in the mass storage unit 403.

Usual procedures for the loading of software into memory and the storage of data in the mass storage unit 403 apply. The processor 401 also accesses, via bus 409, an input/output interface 411 that is configured to receive data from and output data to an external system (e.g. an external network or a user input or output device). The input/output interface 411 may be a single component or may be divided into a separate input interface and a separate output interface.

The ML controller 407 includes a component identification module 413 and an importance module 415. The component identification module 413 is configured to identify components within a received input (set of observed data). The importance module 415 is configured to importance of each component based on the change in the confidence measure after the component has been adjusted or perturbed. This may be through the importance module inputting the adjusted input into a machine learning model itself, or by the importance module sending the adjusted input to an external system that calculates and returns the corresponding confidence measure.

Accordingly, the predictions (e.g. classifications) and corresponding confidence measures may be determined by the ML controller 407 or may be input into the system 400 via the I/O interface 411.

Thus, execution of the ML software 407 by the processor 401 will cause embodiments as described herein to be implemented.

The ML controller 407 may also be configured to output the influence values to the user (via the I/O interface) to provide the user with an indication of the importance of the components.

The ML controller software 407 can be embedded in original equipment, or can be provided, as a whole or in part, after manufacture. For instance, the ML controller software 407 can be introduced, as a whole, as a computer program product, which may be in the form of a download, or to be introduced via a computer program storage medium, such as an optical disk. Alternatively, modifications to an existing ML controller 407 can be made by an update, or plug-in, to provide features of the above described embodiment.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer-implemented method for determining an influence of a component of an input on a prediction generated according to a machine learning model, the method comprising:
obtaining an input comprising observations, each observation including a corresponding value for one or more observable variables;
dividing the input into components, each component comprising a subset of the observations;
obtaining a measure of confidence in a first prediction, the first prediction being generated through inputting the input into the machine learning model;
for each component:
forming an adjusted input by adjusting, within the input, the subset of the observations corresponding to the component;
obtaining a measure of confidence in a second prediction, the second prediction being generated through inputting the adjusted input into the machine learning model; and
determining the influence of the component on the first prediction by calculating a difference between the measure of confidence in the first prediction and the measure of confidence in the second prediction; and
outputting an indication of the influence of one or more of the components.

2. The method of claim 1 wherein the difference in the measure of confidence in the first prediction and the measure of confidence in the second prediction is a difference relative to the measure of confidence in the first prediction.

3. The method of claim 1 wherein:
the machine learning model is a classifier and the measure of confidence in the first prediction is a confidence score for a classification of the input and the measure of confidence in the second prediction is a confidence score for a classification of the adjusted input; or
the measure of confidence in the first prediction is an error in the first prediction and the measure of confidence in the second prediction is an error in the second prediction; or
the first prediction is a first action and the second prediction is a second action and the measure of confidence in the first prediction is a reward for a first action and the measure of confidence in the second prediction is a reward for the second action.

4. The method of claim 1 wherein obtaining a measure of confidence in a first prediction comprises inputting the input into the machine learning model to determine the first prediction and determining the measure of confidence in the first prediction.

5. The method of claim 1 wherein obtaining a measure of confidence in the second prediction comprises inputting the adjusted input into the machine learning model to determine the second prediction and determining the measure of confidence in the second prediction.

6. The method of claim 1 wherein obtaining a measure of confidence in the first prediction comprises:
sending the input to an external system configured to input the input into the machine learning model to determine the first prediction and determine the measure of confidence in the first prediction; and
receiving the measure of confidence in the first prediction from the external system.

7. The method of claim 1 wherein obtaining a measure of confidence in the second prediction comprises:
sending the adjusted input to an external system configured to input the adjusted input into the machine learning model to determine the second prediction and determine the measure of confidence in the second prediction; and
receiving the measure of confidence in the second prediction from the external system.

8. The method of claim 1 wherein:
the input comprises a set of words, with each observation representing a corresponding word; and
each component comprises a corresponding group of one or more words.

9. The method of claim 8 wherein the input is divided into components based on a semantic and/or syntactic classification of each word.

10. The method of claim 9 wherein each component comprises a group of one or more words having a corresponding semantic and/or syntactic classification.

11. The method of claim 10 wherein dividing the input into components comprises one or more of:
identifying one or more words within the input and assigning each word to a corresponding component;
identifying one or more noun phrases within the input and assigning each noun phrase to a corresponding component;
identifying one or more grammatical relations within the input and assigning each grammatical relation to a corresponding component; and
identifying one or more named entities within the input and assigning the each named entity to a corresponding component.

12. The method of claim 11 wherein identifying one or more words comprises identifying one or more words having one of one or more predefined semantic and/or syntactic classifications.

13. The method of claim 12 wherein the one or more predefined semantic and/or syntactic classifications comprise one or more of noun, verb, adjective, adverb, negative, determiner, question word and auxiliary verb.

14. The method of claim 11 wherein identifying one or more named entities comprises identifying one of more groups of one or more words referring to a corresponding entity.

15. The method of claim 14 wherein the corresponding entity comprises one or more of a location, person, organisation, value of currency, percentage, date or time.

16. The method of claim 11 wherein a noun phrase is a phrase having a noun or pronoun at its head.

17. The method of claim 11 wherein a grammatical relation is a pair of words linked by a corresponding syntactic dependency.

18. A computing system comprising one or more processors configured to perform the method of claim 1.

19. A non-transitory computer readable medium comprising instructions that, when executed by one or more processors, cause the one or more processors to perform the method of claim 1.
